(19) United States
(12) Patent Application Publication
(10) Pub. No.: US 2025/0182166 A1
(43) Pub. Date: Jun. 5, 2025

(54) SYSTEM AND METHOD FOR DETERMINING EMOTIONALLY COMPATIBLE CONTENT AND APPLICATION THEREOF

(71) Applicant: YAHOO AD TECH LLC, DULLES, VA (US)

(72) Inventors: Tal Baumel, Holon (IL); Sian Clark, San Francisco, CA (US); Yaroslav Fyodorov, Haifa (IL); Avihai Mejer, Atlit (IL); Dan Pelleg, Haifa (IL); Fiana Raiber, Karmiel (IL); Ali Tabaja, Haifa (IL)

(21) Appl. No.: 19/048,235

(22) Filed: Feb. 7, 2025

Related U.S. Application Data
(63) Continuation of application No. 16/113,447, filed on Aug. 27, 2018, now abandoned.

(51) Int. Cl. G06Q 30/0251; G06N 20/00

(52) U.S. Cl. CPC G06Q 30/0271; G06N 20/00

(57) ABSTRACT

The present teaching relates to a method and system for selecting content. Upon receiving a request with an indication of a first piece of content for selecting one or more pieces of second content to be presented together with the first piece of content, a plurality of pieces of candidate second content are identified. At least one sentiment feature associated with the first piece of content is determined and the one or more pieces of second content are selected from the plurality of pieces of candidate second content based on the at least one sentiment feature of the first piece of content so that the one or more pieces of second content are emotionally compatible with the first piece of content. The one or more pieces of second content are sent in response to the request.

### CROSS REFERENCE TO RELATED APPLICATION

The present application is a Continuation of U.S. patent application Ser. No. 16/113,447, filed on Aug. 27, 2018, entitled “SYSTEM AND METHOD FOR DETERMINING EMOTIONALLY COMPATIBLE CONTENT AND APPLICATION THEREOF”, the contents of which are hereby incorporated by reference in its entirety.

### BACKGROUND

### 1. Technical Field

The present teaching generally relates to data processing. More specifically, the present teaching relates to selecting advertisements in online advertising.

### 2. Technical Background

In the age of the Internet, advertising is a main source of revenue for many Internet companies. Traditionally, providers of goods/services and/or advertising agencies desire to display their advertisements on different platforms. One chief goal in advertising is presenting advertisements in most relevant settings so that the financial return is maximized. This also applies to the Internet world. Online activities offer various advertising opportunities. For example, when a user searches content online, the search engine often presents advertisements together with the search result. In addition, when the user is engaged in viewing a particular content, the content hosts usually present the content with appropriate advertisements.

Conventionally, advertisements presented with online content are selected based on different features. FIG. 1 (PRIOR ART) describes a typical advertisement selection mechanism, which includes a content analyzer 110, an ad information analyzer 120, and an ad selector 140. To select advertisement(s) that is appropriate to the content to be presented to a user, the content analyzer 110 analyzes the content to, e.g., identify topics or concepts conveyed by the content at issue to provide contextual features associated with the content. For example, if the content is an online article about most recent findings on the health food consumption pyramid, the analysis of the content may identify health and diet as topics covered by the content and the contextual features extracted from the content may correspond to something such as healthy diet. Such contextual features may be relied on in selecting appropriate advertisements to be presented to the user viewing the content.

There are other types of features that may also be used in selecting appropriate advertisements. As depicted in FIG. 1, features of available advertisements or ad features may also be extracted and used in selection. Each advertisement has its meta data indicating the content of the advertisement and targeted audience, etc. Features related to the content of the advertisement may be used to match with the contextual features of the content the user is currently viewing, while information related to targeted audience may be used to match with user features (determined based on user profiles 150) to determine whether the user currently viewing the content fits the profile of the targeted audience. Based on the contextual features, ad features, and user features, the ad selector 140 then makes selection of certain advertisement(s) from the ad database 130 as the selected ad(s) to be displayed to the user currently viewing the content.

In some situations, other consideration may also be taken into account in determining what is the appropriate advertisement or compatible content in general to be displayed. Sometimes, the selected advertisements/content, although appropriate from the traditionally considered perspectives, may be emotionally objectionable. For instance, if an online article is about the rescue effort to save children in Africa who continue to die due to famine, although the content is about children, it likely is emotionally objectionable to present advertisements on baby diapers. The traditional advertisement selection approaches do not address this concern by avoiding emotionally objectionable advertisement/content in certain context. Thus, there is a need to devise a solution to address this problem.

### SUMMARY

The teachings disclosed herein relate to methods, systems, and programming for advertising. More particularly, the present teaching relates to methods, systems, and programming related to exploring sources of advertisement and utilization thereof.

An aspect of the present disclosure provides for a method, implemented on a machine having at least one processor, storage, and a communication platform capable of connecting to a network for selecting content. The method includes the steps of: receiving, via the communication platform, a request with an indication of a first piece of content for selecting one or more pieces of second content to be presented together with the first piece of content; identifying a plurality of pieces of candidate second content; determining at least one sentiment feature associated with the first piece of content; selecting the one or more pieces of second content from the plurality of pieces of candidate second content based on the at least one sentiment feature of the first piece of content so that the one or more pieces of second content are emotionally compatible with the first piece of content; and sending the one or more pieces of second content in response to the request.

By one aspect of the present disclosure, there is provided a system for selecting content. The system comprises a content analyzer implemented by at least one processor and configured to receive a request with an indication of a first piece of content for selecting one or more pieces of second content to be presented together with the first piece of content, and determine at least one sentiment feature associated with the first piece of content. The system includes an ad selector implemented by the at least one processor and configured to identify a plurality of pieces of candidate second content. The system includes an emotion-based ad filtering engine implemented by the at least one processor and configured to select the one or more pieces of second content from the plurality of pieces of candidate second content based on the at least one sentiment feature of the first piece of content so that the one or more pieces of second content are emotionally compatible with the first piece of content, and send the one or more pieces of second content in response to the request.

Other concepts relate to software for implementing the present teaching. A software product, in accord with this concept, includes at least one machine-readable non-transitory medium and information carried by the medium. The information carried by the medium may be executable program code data, parameters in association with the executable program code, and/or information related to a user, a request, content, or other additional information.

In one example, a machine-readable, non-transitory and tangible medium having data recorded thereon for selecting content, wherein the medium, when read by the machine, causes the machine to perform a series of steps, including: receiving, via the communication platform, a request with an indication of a first piece of content for selecting one or more pieces of second content to be presented together with the first piece of content; identifying a plurality of pieces of candidate second content; determining at least one sentiment feature associated with the first piece of content; selecting the one or more pieces of second content from the plurality of pieces of candidate second content based on the at least one sentiment feature of the first piece of content so that the one or more pieces of second content are emotionally compatible with the first piece of content; and sending the one or more pieces of second content in response to the request.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 (PRIOR ART) describes a traditional mechanism for selecting advertisements relevant to content;

FIG. 2A-2C depict different operational configurations of emotion-based advertisement filtering in a network setting, according to different embodiments of the present teaching;

FIG. 3A depicts an exemplary high-level system diagram of an emotion-based advertisement filtering engine, according to an embodiment of the present teaching;

FIG. 3B depicts an exemplary high-level system diagram of an emotion-based advertisement filtering engine, according to a different embodiment of the present teaching;

FIGS. 3C-3D depict different operational configurations of emotion-based advertisement selection and filtering in a network setting, according to some embodiments of the present teaching;

FIG. 4A depicts an exemplary high-level system diagram of a content analyzer, according to some embodiments of the present teaching;

FIG. 4B is a flowchart of an exemplary process for training a sentiment feature extraction model via machine learning, according to an embodiment of the present teaching;

FIG. 4C is a flowchart of an exemplary process of a content analyzer that extracts sentiment features based on a sentiment feature extraction model, according to an embodiment of the present teaching;

FIG. 5A depicts an exemplary high-level system diagram of an emotion-based ad filtering engine, according to an embodiment of the present teaching;

FIG. 5B is a flowchart of an exemplary process of an emotion-based ad filtering engine, according to an embodiment of the present teaching;

FIG. 6A depicts a different exemplary high-level system diagram of an emotion-based ad filtering engine, according to an embodiment of the present teaching;

FIG. 6B is a flowchart of an exemplary process of another emotion-based ad filtering engine, according to an embodiment of the present teaching;

FIG. 7 depicts the architecture of a mobile device which can be used to implement a specialized system incorporating the present teaching; and

FIG. 8 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details or with different details related to design choices or implementation variations. In other instances, well known methods, procedures, components, and/or hardware/software/firmware have been described at a relatively high-level, without detail, in order to avoid unnecessarily obscuring aspects of the present teachings.

The present disclosure generally relates to systems, methods, medium, and other implementations directed to selecting appropriate content, including but not limited to advertisements, by filtering out emotionally objectionable items. In the illustrated embodiments of the present teaching, the related concepts are presented in the online networked operational environment in which the present teaching is deployed. However, it is understood that the present teaching can be applied to any setting where selecting emotionally compatible content is needed. In addition, although the present teaching is presented in relation to advertisement selection, the concepts of the present teaching can be used to select any types of emotionally appropriate or compatible content without limitation.

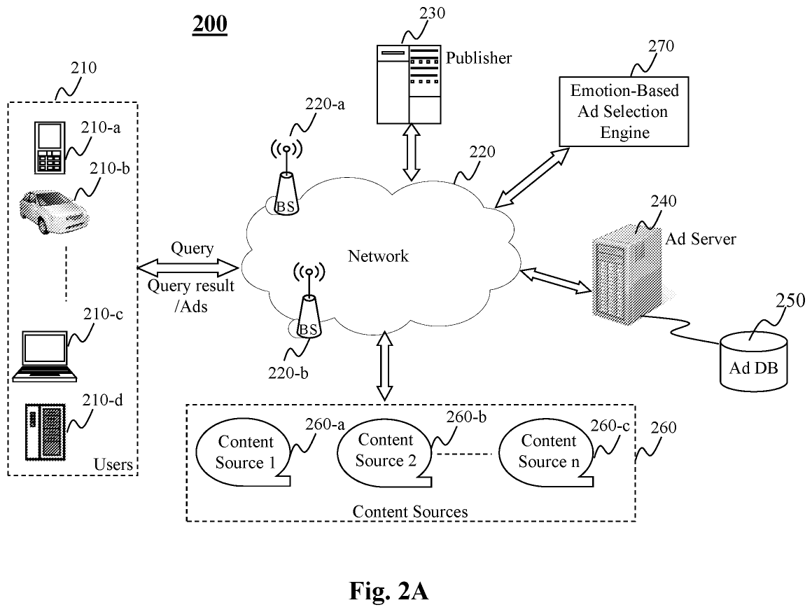

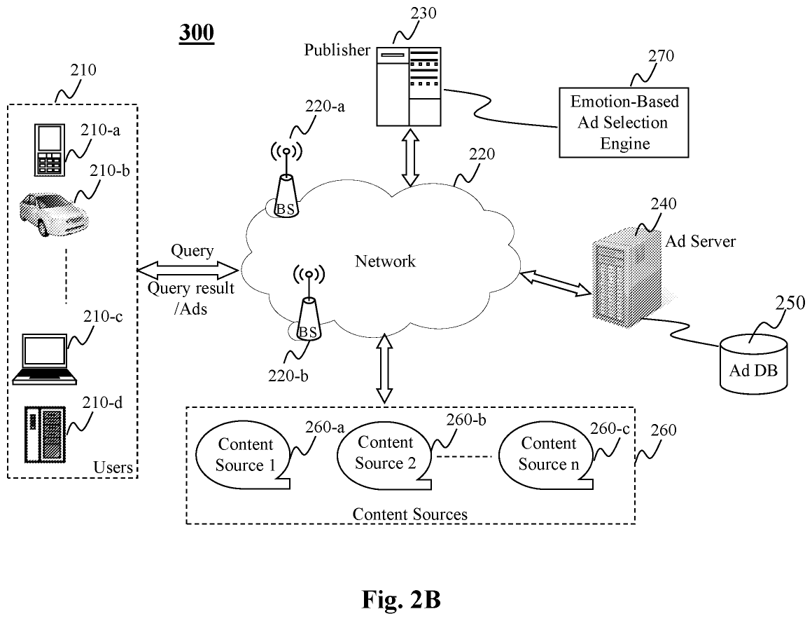

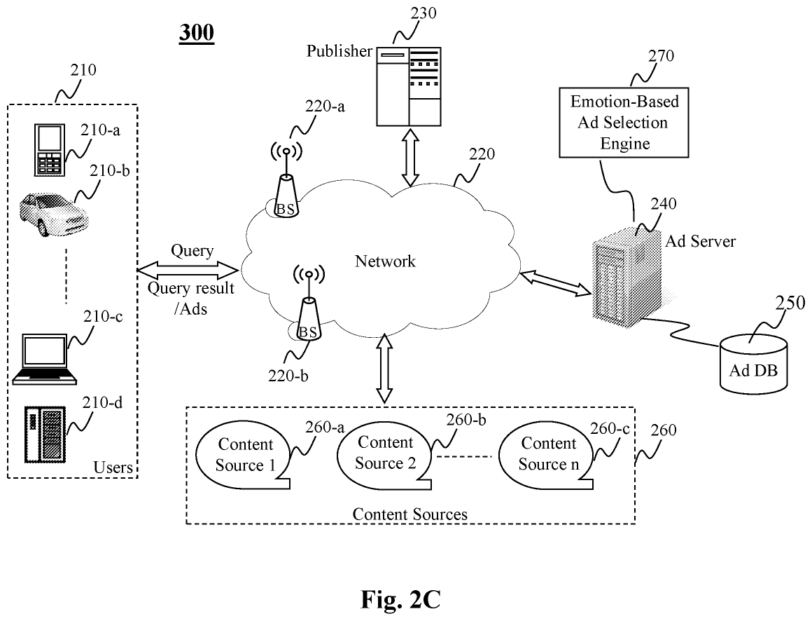

FIG. 2A-2C depict different operational configurations of emotion-based advertisement filtering in a network setting, according to different embodiments of the present teaching. In FIG. 2A, an exemplary system configuration 200 includes users 210, a network 220, an exemplary publisher 230, content sources 260 including content source 1 260-a, content source 2 260-b, . . . , content source n 260-c, an advertisement server 240, and an emotion-based ad selection engine 270. In this illustrated embodiment, the emotion-based ad selection engine 270 provides the service of selecting emotionally compatible advertisement based on content associated with a user. The content herein may refer to both online content currently viewed by a user or a user query. The advertisement(s) selected by the emotion-based ad selection engine 270 may be determined on the basis that it is not emotionally objectionable with respect to the content.

In this embodiment, the emotion-based ad selection engine 270 is connected to the network 220 as, e.g., an independent service engine. That is, it receives a service request for identifying advertisement(s) based on information provided by the publisher 230 indicating the current content (which may be online content currently displayed to a user or a query from a user) and candidate advertisements from the advertisement server 250, both received via the network 220. Based on the request, the emotion-based ad selection engine 270 determines advertisement(s) that are emotionally appropriate for the content and returns the selected advertisement(s) to the publisher 230 via the network 220. In this embodiment, as the emotion-based ad selection engine 270 is a stand-alone service, it may provide its services to a plurality of publishers 230 and a plurality of advertisement servers 240 (not shown plurality of each). In some applications, the emotion-based ad selection engine 270 may also be used to select emotionally compatible content based on a request from, e.g., the publisher 230.

In FIG. 2B, an alternative configuration is provided, in which the emotion-based ad selection engine 270 is connected to a publisher 230 as its backend service engine. That is, in this embodiment, the emotion-based ad selection engine 270 is a special module in the backend of the publisher 230. When there are multiple publishers (not shown), each may have its own backend module for selecting emotionally compatible advertisements to be presented together with content. In addition to selecting emotionally compatible advertisements, the emotion-based ad selection engine 270 may also be used to select emotionally compatible content for the publisher 230.

In FIG. 2C, yet another alternative configuration is provided, in which the emotion-based ad selection engine 270 is connected to an advertisement server 240 as a backend service engine. That is, in this embodiment, the emotion-based ad selection engine 270 is a special module in the backend of an advertisement server 240. When there are multiple advertisement servers, each may have its own backend module for selecting emotionally compatible advertisements with respect to a request for an advertisement.

In FIGS. 2A-2C, the network 220 may be a single network or a combination of different networks. For example, a network may be a local area network (LAN), a wide area network (WAN), a public network, a private network, a proprietary network, a Public Telephone Switched Network (PSTN), the Internet, a wireless network, a cellular network, a Bluetooth network, a virtual network, or any combination thereof. The network 220 may also include various network access points, e.g., wired or wireless access points such as base stations or Internet exchange points (not shown) through which a data source may connect to the network 220 in order to transmit/receive information via the network.

In some embodiments, the network 220 may be an online advertising network or an ad network, which connects the emotion-based ad selection engine 270 to/from the publisher 230 or websites/mobile applications hosted thereon that desire to receive or display advertisements. Functions of an ad network include an aggregation of ad-space supply from the publisher 230, ad supply from the advertisement server 240, and selected advertisements in each scenario that not only match with queries from users but also emotionally compatible with respect to the content surrounding the ad-space. An ad network may be any type of advertising network environments such as a television ad network, a print ad network, an online (Internet) ad network, or a mobile ad network.

The publisher 230 can be a content provider, a search engine, a content portal, or any other sources from which content can be published. The publisher 230 may correspond to an entity, whether an individual, a firm, or an organization, publishing or supplying content, including, e.g., a blogger, television station, a newspaper issuer, a web page host, a content portal, an online service provider, or a game server. For example, in connection to an online or mobile ad network, publisher 230 may also be an organization such as USPTO.gov and CNN.com, or a content portal such as YouTube and Yahoo.com, or a content-soliciting/feeding source such as Twitter, Facebook, or blogs. In one example, content sent to a user may be generated or formatted by the publisher 230 based on data provided by or retrieved from the content sources 260.

The content sources 260 may correspond to content/app providers, which may include, but not limited to, an individual, a business entity, or a content collection agency such as Twitter, Facebook, or blogs, that gather different types of content, online or offline, such as news, papers, blogs, social media communications, magazines, whether textual, audio or visual, such as images or video content. The publisher may also be a content portal presenting content originated by a different entity (either an original content generator or a content distributor). Examples of a content portal include, e.g., Yahoo! Finance, Yahoo! Sports, AOL, and ESPN. The content from content sources 260 include multi-media content or text or any other form of content including website content, social media content from, e.g., Facebook, Twitter, Reddit, etc., or any other content generators. The gathered content may be licensed content from providers such as AP and Reuters. It may also be content crawled and indexed from various sources on the Internet. Content sources 260 provide a vast range of content that are searchable or obtainable by the publisher 230.

Users 210 may be of different types such as ones connected to the network via wired or wireless connections via a device such as a desktop, a laptop, a handheld device, a built-in device embedded in a vehicle such as a motor vehicle, or wearable devices (e.g., glasses, wrist watch, etc.). In one embodiment, users 210 may be connected to the network 220 to access and interact with online content with ads (provided by the publisher 230) displayed therewith, via wired or wireless means, through related operating systems and/or interfaces implemented within the relevant user interfaces.

In operation, a request for an advertisement from the publisher 230 is received by the advertisement server 240, which may be centralized or distributed. The advertisement server 240 may archive data related to a plurality of advertisements in an advertisement database 250, which may or may not reside in the cloud. The advertisement server 240 operates to distribute advertisements to appropriate ad placement opportunities on different platforms. The advertisements accessible by the advertisement server 240 may include some textual information, e.g., a description of what the advertisement is about as well as additional information such as target audience as well as certain distribution criteria related to, e.g., geographical coverage or timing related requirements. Target audience may be specified in terms of, e.g., demographics of the target audience, the distribution criteria may specify geographical locations of the target audience, and/or time frame(s) the advertisement is to be distributed to the target audience. When a request is received from the publisher 230 for an advertisement, either the publisher 230 or the advertisement server 240 may invoke the emotion-based ad selection engine 270 to identify appropriate candidate advertisements for the specific placement. As disclosed herein, according to the present teaching, appropriate advertisements to be selected are not only suitable content-wise given the content to be provided to the user but also compatible with respect to the emotion detected from the content. The emotion-based ad selection engine 270 ensures that the selected advertisement(s) is not emotionally objectionable given the content provided.

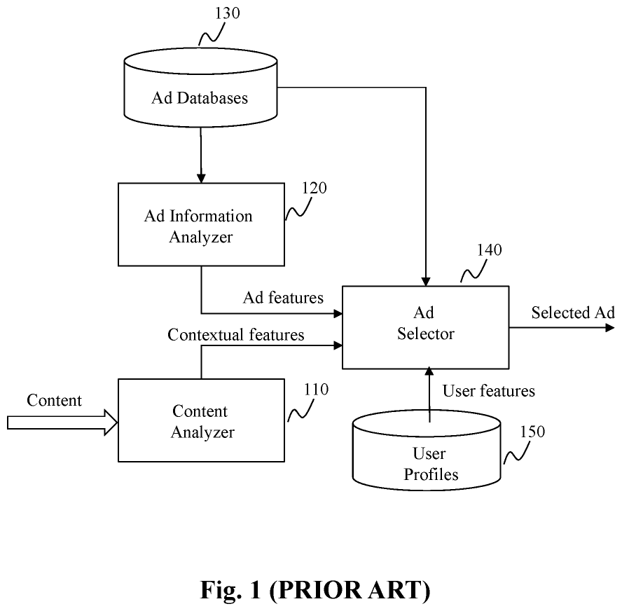

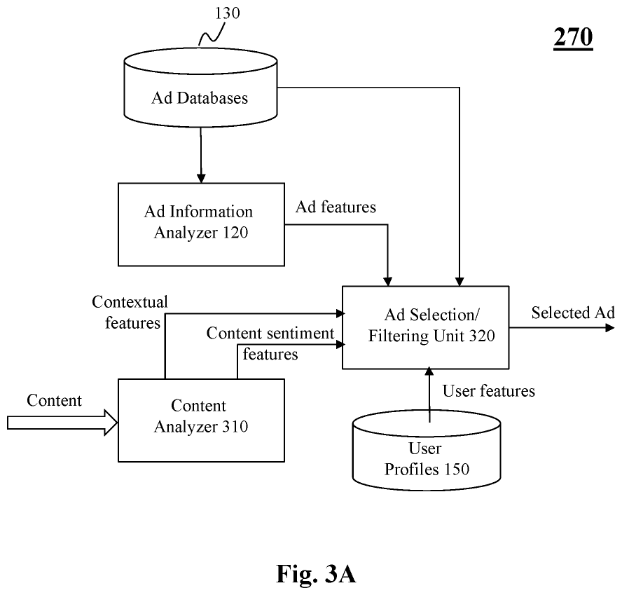

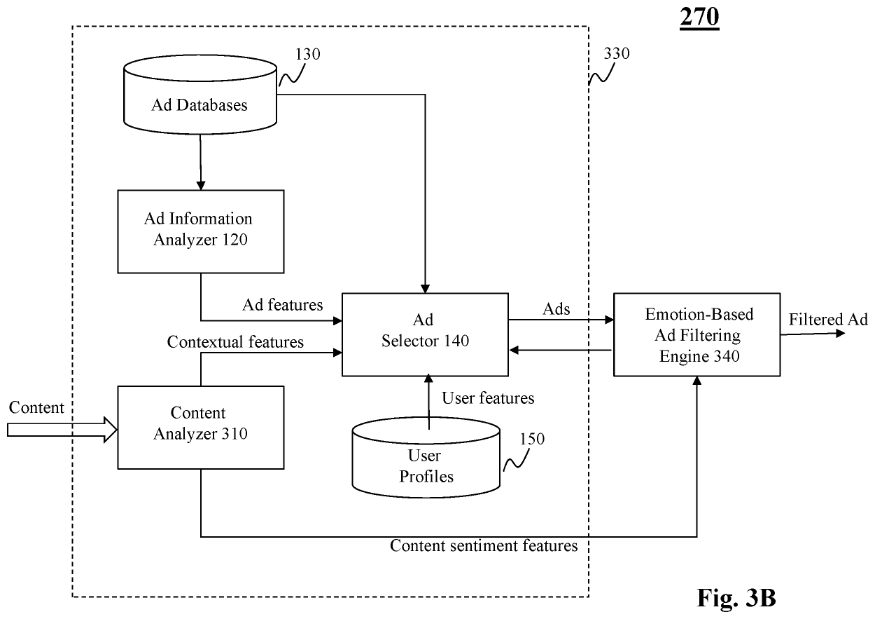

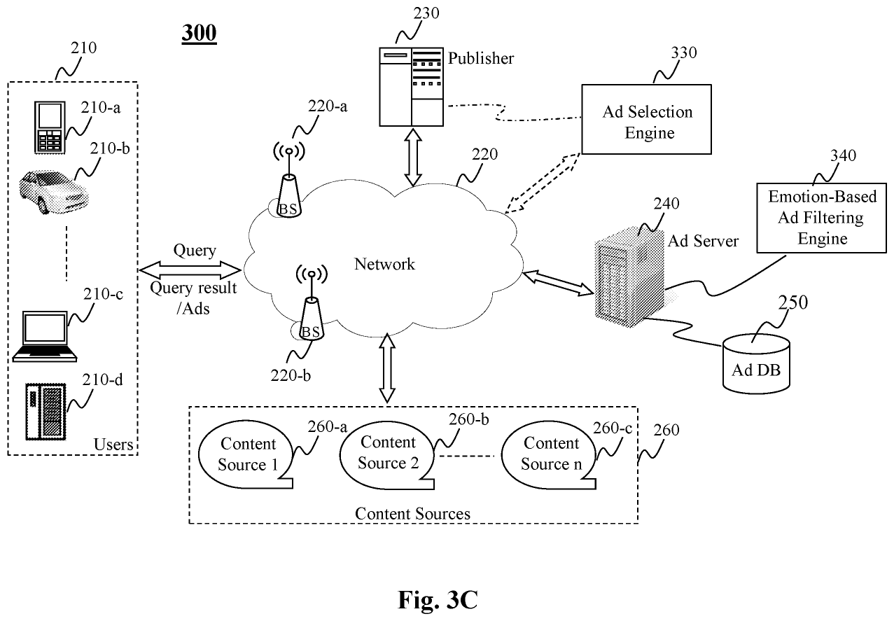

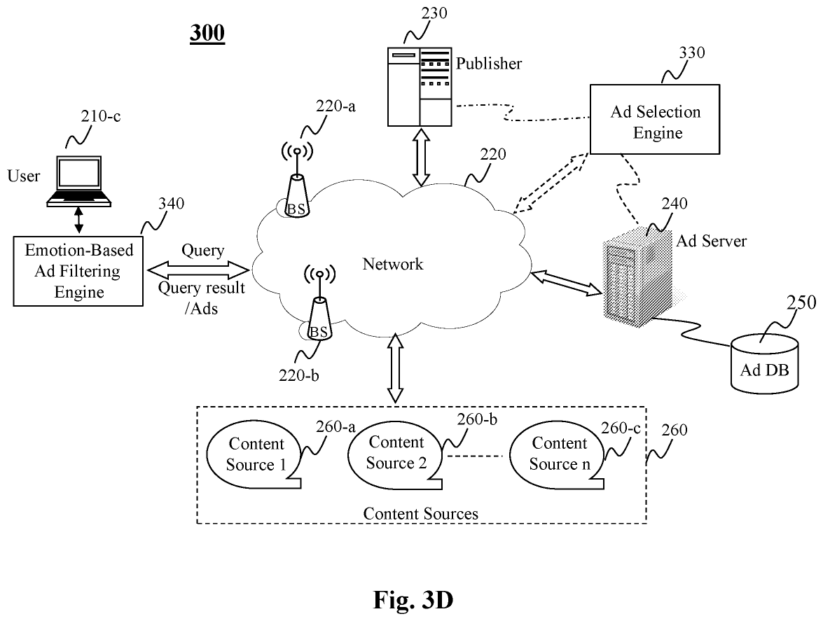

FIG. 3A depicts an exemplary high-level system diagram of the emotion-based ad selection engine 270, according to an embodiment of the present teaching. In this illustrated embodiment, the emotion-based ad selection engine 270 comprises a content analyzer 310, an ad information analyzer 120, and an ad selection/filtering unit 320. The content analyzer 310 receives content to be provided to the user and analyzes it to extract both contextual features (e.g., topics) and content sentiment features which associate with emotions of the content. Such detected contextual and sentiment features are then sent to the ad selection/filtering unit 320 so that advertisement(s) may be selected/filtered by matching the contextual/sentiment features with corresponding features of the advertisements. To do so, the ad selection/filtering unit 320 receives ad features from the ad information analyzer 120 (which functions the same way as a traditional ad analyzer as depicted in FIG. 1) and related information about the stored advertisements from the ad databases 130. Based on the received features, the ad selection/filtering unit 320 identifies advertisement(s) that meet both the traditional requirements (appropriate in terms of contextual features, target audience, distribution criteria, etc.) and the requirement of being emotionally compatible with the content in hand. The selected advertisement is then output and sent to the publisher 230 or advertisement server 240 (depending on from where the request for ad is received).

FIG. 3B depicts an exemplary high level system diagram of the emotion-based ad selection engine 270, according to a different embodiment of the present teaching. In this illustrated embodiment, the emotion-based ad selection engine 270 comprises two parts, one part for selecting candidate advertisements based on traditional requirements and the other for filtering the selected candidate advertisements based on sentiment related requirements. Although the overall engine achieves the same functionality as to selecting advertisements that are both content-wise and sentiment-wise appropriate, this implementation of separating ad selection and emotion-based filtering enable these two parts to reside at different locations in the network and hence, more flexible in terms of deployment.

In this illustrated embodiment, the emotion-based ad selection engine 270 comprises an ad selection component 330 and an emotion-based ad filtering engine 340. The ad selection component 330 further comprises a content analyzer 310, an ad information analyzer 120, and an ad selector 140. As can be seen herein the ad selection component 330 is constructed similarly as a traditional ad selection engine (as depicted in FIG. 1) except that the content analyzer 310 in FIG. 3B is configured to also extract content sentiment features (in addition to the traditional contextual features) in order to send to the emotion-based ad filtering engine 340 to facilitate it to filter out advertisements that are not emotionally compatible with the sentiment feature of the content.

With the ad selection engine 330 and emotion-based ad filtering engine 340 being separate components in this embodiment, FIGS. 3C-3D depict potentially different operational configurations of selecting emotionally compatible advertisements in a network setting, according to some embodiments of the present teaching. As depicted in FIG. 3C, the ad selection engine 330 may reside either independently on the network as a service vendor or in the backend of the publisher 230, while the emotion-base ad filtering engine 340 may reside in the backend of the ad server 240. In this embodiment, the selected ads by the ad selection engine 330 may be filtered in different manners. For instance, the selected ads may be filtered by the ad server based on, e.g., some criteria employed that specify different types of sentiments (emotions) that may not be compatible. For example, if content is about death and injuries of people (including children) that occurred in a natural disaster with detected sentiment features related to sadness and sympathy, a selected advertisement on hosting fun birthday parties with sentiment features of happiness and fun may be specified as incompatible or even objectionable to each other.

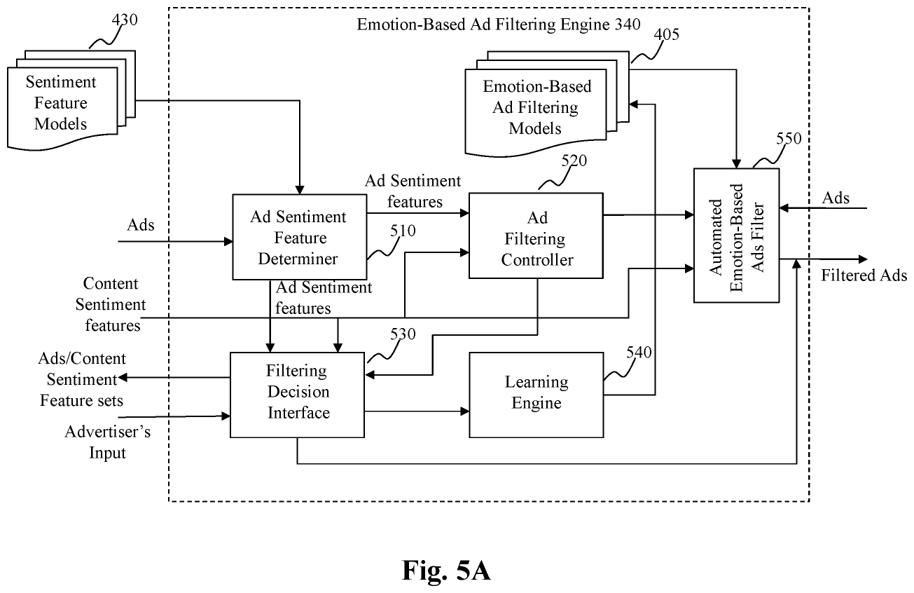

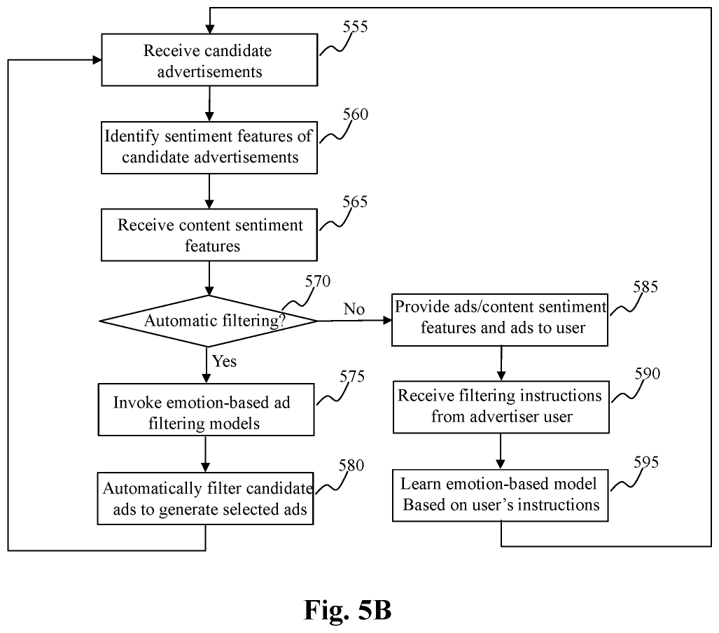

Filtering criteria on what are incompatible advertisements may be manually specified or learned from examples. Humans may specify, for instance, that sadness/sympathy sentiment features are not compatible with happiness/fun sentiment features. The criteria about incompatibilities may also be learned from human activities over time. For example, emotion-based filtering may be initially performed by humans (e.g., personnel at the ad server 240 or at the publisher 230) and such filtering instructions may be used as training data to train a model. Such a trained model may then be used to perform automated filtering of emotionally incompatible advertisements given certain content with detected sentiment features. Details related to establishing an emotion-based ad filtering model are provided with reference to FIGS. 5A-5B.

When the emotion-based ad filtering model is available, the selected ads may also be filtered automatically at the client device before the filtered ad(s) is to be displayed together with the content. This is depicted in FIG. 3D. In this embodiment, the selected ads from the ad selection engine 330 (residing either independently on the network or being connected to the publisher 230 or the ad server 240 in the backend) may be received by the client/user device with, e.g., detected content/ads sentiment features. In some embodiments, the sentiment features may also be extracted by the emotion-based ad filtering engine 340 at the time of the filtering so that the emotionally incompatible ads can be filtered out based on sentiment features.

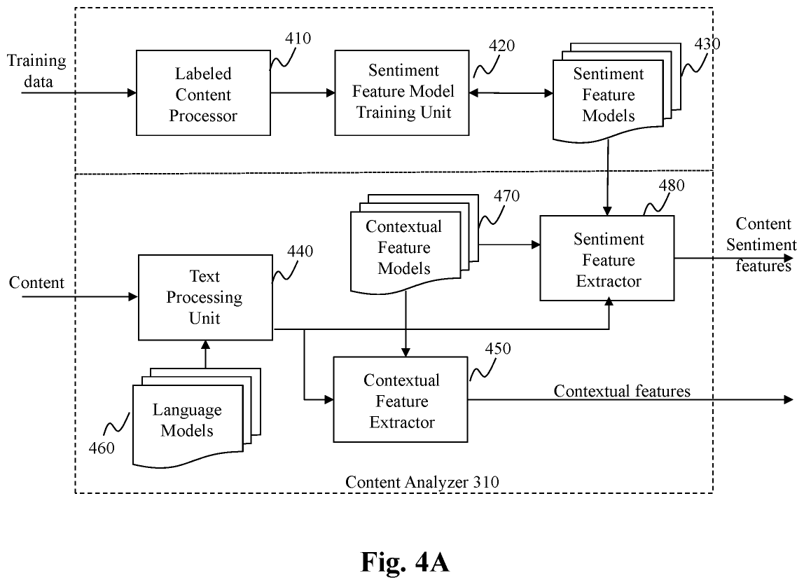

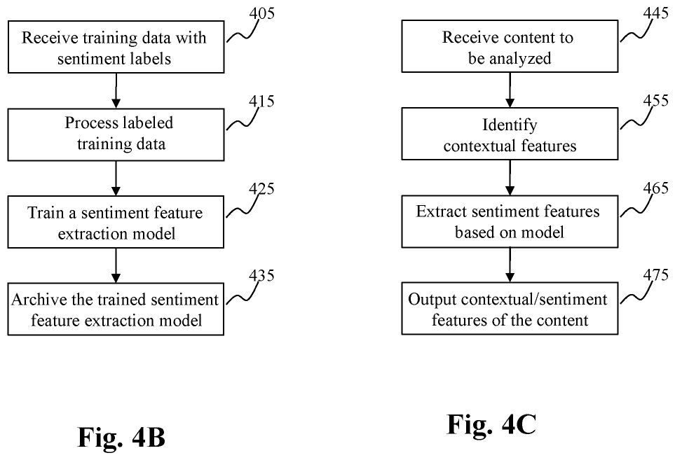

FIG. 4A depicts an exemplary high-level system diagram of the content analyzer 310, according to some embodiments of the present teaching. In this illustrated embodiment, the content analyzer 310 may comprise two parts, one for generating sentiment feature models to be used for extracting sentiment features from content, while the other part for processing given content to extract contextual features and content sentiment features based on the established sentiment feature models. For generating the sentiment feature models 430, the first part of the content analyzer 310 may correspond to an offline mechanism which comprises a labeled content processor 410 and a sentiment feature model training unit 420. FIG. 4B is a flowchart of an exemplary process for generating sentiment feature models. In operation, this offline portion receives, at 405, training data (labeled with sentiment features) and processes, at 415, the received training data. The processed training data is then used by the sentiment feature model training unit 420 to train, at 425, and obtain the sentiment feature models 430. Such derived models may then be saved, at 435, so that they may be used in operation to extract sentiment features from received content.

As discussed herein, the online part of the content analyzer 310 is for extracting both contextual and sentiment features from a given piece of content. In this illustrated embodiment, this part comprises a text processing unit 440, a contextual feature extractor 450, and a sentiment feature extractor 480. FIG. 4C is a flowchart of an exemplary process of the online portion of the content analyzer 310 that extracts different types of features, according to an embodiment of the present teaching. When content is received, at 445, by the text processing unit 440, it processes the content based on, e.g., appropriate language models 460. The processed result is sent to both the contextual feature extractor 450 and the sentiment feature extractor 480 so that different features may be extracted. The contextual feature extractor 450 identifies, at 455, contextual features from the processed content based on, e.g., traditional contextual feature models 470. The sentiment feature extractor 480 then extracts, at 465, content sentiment features based on the sentiment feature models 430. Such extracted features, both contextual and sentimental, are then output, at 475, for ad selection and filtering. As discussed herein, depending on the specific configuration (e.g., selection and filtering performed at the same location as depicted in FIGS. 2A-2C, and selection and filtering performed at different locations as depicted in FIG. 3C-3D), the contextual features and the content detected sentiment features may be sent to the same or different components for further use.

FIG. 5A depicts an exemplary high-level system diagram of the emotion-based ad filtering engine 340, according to an embodiment of the present teaching. As discussed herein, the emotion-based ad filtering engine 340 is for filtering out emotionally incompatible advertisements, based on selected advertisement candidates (via normal ad selection mechanism), to ensure that an advertisement to be displayed with the content is not emotionally objectionable given the sentiment detected from the content. In this illustrated embodiment, the emotion-based ad filtering engine 340 comprises an ad sentiment feature determiner 510, an ad filtering controller 520, a filtering decision interface 530, an automated emotion-based ad filter 550, and a learning engine 540. In some embodiments, this illustrated embodiment of the emotion-based ad filtering engine 340 includes a mechanism for learning emotion-based ad filtering models 405 based on instructions/inputs from humans and is therefore suitable for certain configurations as depicted in FIGS. 2A-2C and FIG. 3C (where the emotion-based ad filtering engine 340 does not reside on a client/user device).

FIG. 5B is a flowchart of an exemplary process of the emotion-based ad filtering engine 340 as illustrated in FIG. 5A, according to an embodiment of the present teaching. In operation, when initially selected candidate advertisements are received, at 555, by the ad sentiment feature determiner 510, it identifies, at 560, sentiment features of each of the candidate advertisements based on the sentiment feature models 430. Such identified ad sentiment features are then sent to the ad filtering controller 520, which also receives, at 565, the content sentiment features extracted from the content by the content analyzer 330 from the content to be presented to the user. Based on the received features, the ad filtering controller determines, at 570, whether the filtering is to be performed manually or automatically.

As discussed herein, in some embodiments, initial filtering may be performed by human operators and data related to such manual filtering may be used as training data to learn emotion-based ad filtering models 405. For example, if human operators repeatedly filter out advertisements with happiness and fun sentiment features when the content to be provided with such advertisements has sadness sentiment features, training using such data may yield models that dictate that when sentiment features sadness for one and happiness/fun for another are detected, then the underlying two (content and advertisement) are not emotionally compatible and should not be provided together. When a large number of training data are collected and used to train the emotion-based ad filtering models 405, the models may become reliable so that they can be used for automated emotion-based ad filtering.

The ad filtering controller 520 may control to proceed with either manual or automated emotion-based ad filtering based on, e.g., whether the models 405 are available or whether the models have been trained adequately. If manual filtering is determined at 570, the ad filtering controller 520 activates the filtering decision interface 530 and provides, at 585, the sentiment features extracted from both content and the candidate advertisements to the filtering decision interface 530 so that such sentiment features may be presented to a user for decision making purposes. When the user manually provides input related to the filtering decisions, the filtering decision interface 530 receives, at 590, such filtering instructions and then outputs the filtered advertisement(s) that are emotionally compatible with respect to the content. At the same time, to establish the emotion-based ad filtering models 405, the user's filtering decision information is sent to the learning engine 540 so that the user specified input may be gathered to learn, at 595, the emotion-based ad filtering models 405.

When the emotion-based ad filtering models 405 are adequately trained or in other conditions, the ad filtering controller 520 may elect to proceed with automated emotion-based ad filtering. In this case, the ad filtering controller 520 activates the automated emotion-based ad filter 550, which may then invoke, at 575, the emotion-based ad filtering models 405. Based on the sentiment features extracted from content and the candidate advertisements, the automated emotion-based ad filter 550 filters, at 580 and based on the emotion-based ad filtering models 405, the candidate advertisements to generate filtered advertisements.

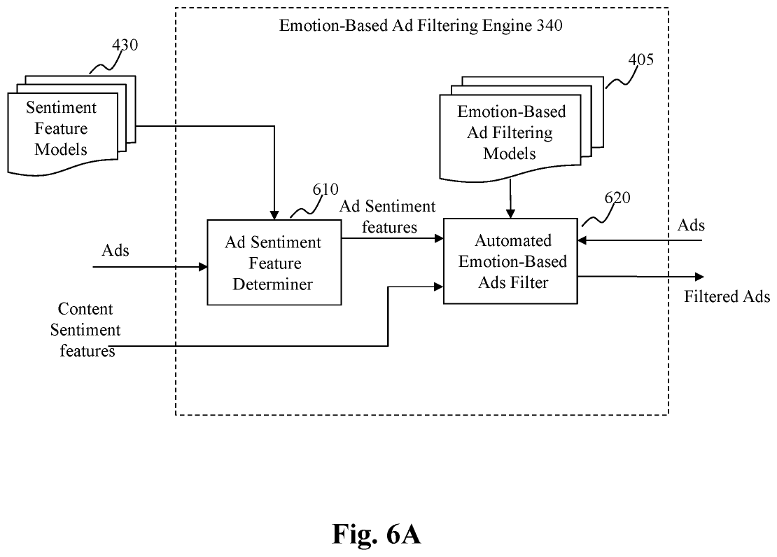

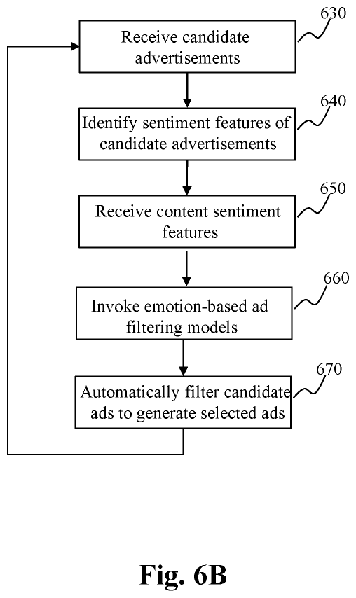

FIG. 6A depicts another exemplary high-level system diagram of the emotion-based ad filtering engine 340, according to an embodiment of the present teaching. This illustrated embodiment of the emotion-based ad filtering engine 340 is suitable for the configuration as depicted in FIG. 3D, where the emotion-based ad filtering engine 340 is deployed at a client/user device for automated emotion-based ad filtering. In this embodiment, the emotion-based ad filtering engine 340 comprises an ad sentiment feature determiner 610 and an automated emotion-based ad filter 620. FIG. 6B is a flowchart of an exemplary process for the emotion-based ad filtering engine 340, according to the embodiment depicted in FIG. 6A of the present teaching. In this embodiment, the trained emotion-based ad filtering models 405 are deployed in the emotion-based ad filtering engine 340 and the automated filtering is applied when candidate advertisements and information related to the content (contextual features and content sentiment features) is received to generate filtered advertisements that are emotionally compatible with the sentiment of the content.

In operation, when initially selected candidate advertisements are received, at 630, by the ad sentiment feature determiner 610, it identifies, at 640, advertisement sentiment features of each of the candidate advertisements based on the sentiment feature models 430. Such detected advertisement sentiment features are then used for filtering out candidate advertisement that are not emotionally compatible with the content. To do so, the content sentiment features are received, by the automated emotion-based ad filter 620, at 650, and deployed emotion-based ad filtering models 405 are invoked, at 660, to automatically filter out those advertisements that are considered emotionally incompatible given the content sentiment features and the ad sentiment features.

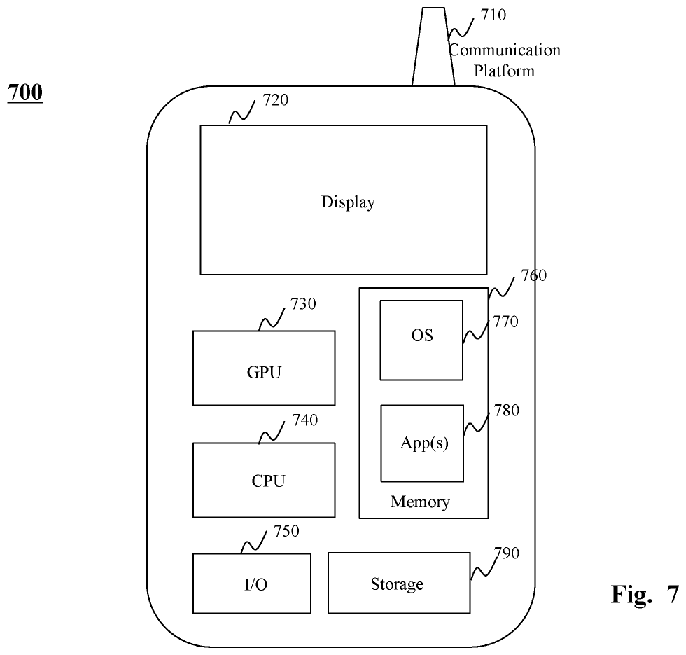

FIG. 7 depicts the architecture of a mobile device which can be used to realize a specialized system, either partially or fully, implementing the present teaching. In this example, the user device on which content and advertisement are presented and interacted—with is a mobile device 700, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 700 in this example includes one or more central processing units (CPUs) 740, one or more graphic processing units (GPUs) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770, e.g., iOS, Android, Windows Phone, etc., and one or more applications 780 may be loaded into the memory 760 from the storage 790 in order to be executed by the CPU 740. The applications 780 may include a browser or any other suitable mobile apps for receiving and rendering content streams and advertisements on the mobile device 700. Communications with the mobile device 700 may be achieved via the I/O devices 750.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to selecting advertisements as disclosed herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

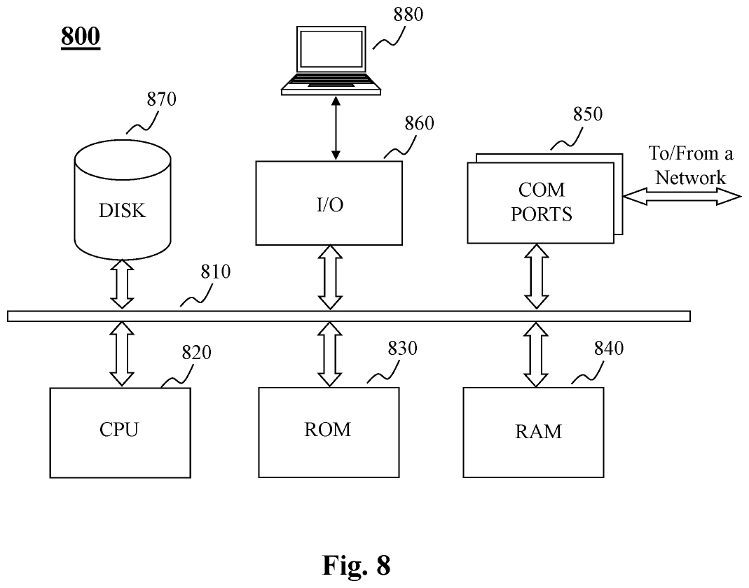

FIG. 8 depicts the architecture of a computing device which can be used to realize a specialized system implementing the present teaching. Such a specialized system incorporating the present teaching has a functional block diagram illustration of a hardware platform which includes user interface elements. The computer may be a general-purpose computer or a special purpose computer. Both can be used to implement a specialized system for the present teaching. This computer 800 may be used to implement any component of the present teaching, as described herein. For example, the emotion-based ad selection engine 270 may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

The computer 800, for example, includes COM ports 850 connected to and from a network connected thereto to facilitate data communications. The computer 800 also includes a central processing unit (CPU) 820, in the form of one or more processors, for executing program instructions. The exemplary computer platform includes an internal communication bus 810, program storage and data storage of different forms, e.g., disk 870, read only memory (ROM) 830, or random-access memory (RAM) 840, for various data files to be processed and/or communicated by the computer, as well as possibly program instructions to be executed by the CPU. The computer 800 also includes an I/O component 860, supporting input/output flows between the computer and other components therein such as user interface elements 880. The computer 800 may also receive programming and data via network communications.

Hence, aspects of the methods of enhancing ad serving and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other systems into the hardware platform(s) of a computing environment or other system implementing a computing environment or similar functionalities in connection with query/ads matching. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the enhanced ad serving based on user curated native ads as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method for online advertising, comprising:
receiving, by an engine, candidate advertisements that match contextual features of online content to be displayed;
determining sentiment features for the online content and each of the candidate advertisements;
if an emotion-based ad filtering model is available, filtering automatically the candidate advertisements using the emotion-based ad filtering model to select one or more of the candidate advertisements with sentiment features matching with the sentiment features of the online content;
if the emotion-based ad filtering model is not yet available,
presenting the sentiment features to a user to seek a filtering instruction,
identifying, based on the filtering instruction, one or more of the candidate advertisements to be displayed together with the online content, and
training, via machine learning, the emotion-based ad filtering model based on the filtering instruction and the identified one or more of the candidate advertisements; and
providing the one or more of the candidate advertisements to be displayed together with the online content.

2. The method of claim 1, further comprising:
receiving a request with an indication of the online content for selecting the one or more of the candidate advertisements to be displayed together with the online content.

3. The method of claim 2, wherein the candidate advertisements that match contextual features of online content are identified based on at least some of:
one or more contextual features associated with the online content; and
one or more features associated with each piece of the candidate advertisements; and
information associated with a user to whom the online content and the one or more of the candidate advertisements are to be presented.

4. The method of claim 1, wherein the sentiment features of the online content reflect an emotion expressed by the online content.

5. The method of claim 1, wherein the contextual features of online content are determined based on a language model.

6. The method of claim 1, wherein the one or more of the candidate advertisements to be displayed together with the online content are emotionally compatible with the online content.

7. The method of claim 1, wherein the filtered-out candidate advertisements are emotionally incompatible with the online content.

8. A non-transitory, computer-readable medium having information recorded thereon for online advertising, wherein the information, when read by a machine, causes the machine to perform operations comprising:
receiving candidate advertisements that match contextual features of online content to be displayed;
determining sentiment features for the online content and each of the candidate advertisements;
if an emotion-based ad filtering model is available, filtering automatically the candidate advertisements using the emotion-based ad filtering model to select one or more of the candidate advertisements with sentiment features matching with the sentiment features of the online content;
if the emotion-based ad filtering model is not yet available,
presenting the sentiment features to a user to seek a filtering instruction,
identifying, based on the filtering instruction, one or more of the candidate advertisements to be displayed together with the online content, and
training, via machine learning, the emotion-based ad filtering model based on the filtering instruction and the identified one or more of the candidate advertisements; and
providing the one or more of the candidate advertisements to be displayed together with the online content.

9. The medium of claim 8, wherein the operations further comprise:
receiving a request with an indication of the online content for selecting the one or more of the candidate advertisements to be displayed together with the online content.

10. The medium of claim 9, wherein the candidate advertisements that match contextual features of online content are identified based on at least some of:
one or more contextual features associated with the online content; and
one or more features associated with each piece of the candidate advertisements; and
information associated with a user to whom the online content and the one or more of the candidate advertisements are to be presented.

11. The medium of claim 8, wherein the sentiment features of the online content reflect an emotion expressed by the online content.

12. The medium of claim 8, wherein the contextual features of online content are determined based on a language model.

13. The medium of claim 8, wherein the one or more of the candidate advertisements to be displayed together with the online content are emotionally compatible with the online content.

14. The medium of claim 8, wherein the filtered-out candidate advertisements are emotionally incompatible with the online content.

15. A system for online advertising, comprising:
memory storing computer program instructions; and
one or more processors that, in response to executing the computer program instructions, effectuate operations comprising:
receiving candidate advertisements that match contextual features of online content to be displayed;
determining sentiment features for the online content and each of the candidate advertisements;
if an emotion-based ad filtering model is available, filtering automatically the candidate advertisements using the emotion-based ad filtering model to select one or more of the candidate advertisements with sentiment features matching with the sentiment features of the online content;
if the emotion-based ad filtering model is not yet available,
presenting the sentiment features to a user to seek a filtering instruction,
identifying, based on the filtering instruction, one or more of the candidate advertisements to be displayed together with the online content, and
training, via machine learning, the emotion-based ad filtering model based on the filtering instruction and the identified one or more of the candidate advertisements; and
providing the one or more of the candidate advertisements to be displayed together with the online content.

16. The system of claim 15, wherein the operations further comprise:
receiving a request with an indication of the online content for selecting the one or more of the candidate advertisements to be displayed together with the online content.

17. The system of claim 16, wherein the candidate advertisements that match contextual features of online content are identified based on at least some of:
one or more contextual features associated with the online content; and
one or more features associated with each piece of the candidate advertisements; and
information associated with a user to whom the online content and the one or more of the candidate advertisements are to be presented.

18. The system of claim 15, wherein the sentiment features of the online content reflect an emotion expressed by the online content.

19. The system of claim 15, wherein the contextual features of online content are determined based on a language model.

20. The system of claim 15, wherein the one or more of the candidate advertisements to be displayed together with the online content are emotionally compatible with the online content.
